(19) United States
(12) Patent Application Publication
(10) Pub. No.: US 2016/0341620 A1
(43) Pub. Date: Nov. 24, 2016

(54) METHOD AND SYSTEM FOR MONITORING PRESSURE IN A GAS CONTAINMENT UNIT

(71) Applicant: Airgas, Inc., Cheshire, CT (US)

(72) Inventors: Jeffrey Perkins, New Britain, CT (US); Edward Desplaines, Cheshire, CT (US)

(21) Appl. No.: 14/718,521

(22) Filed: May 21, 2015

(51) Int. Cl. G01L 19/00; G01L 19/12; G01L 19/08

(52) U.S. Cl. CPC G01L 19/0092; G01L 19/083; G01L 19/12

(57) ABSTRACT

A gas pressure measurement system configured to indirectly measure an internal pressure of a gas containment unit includes (a) a pressure transducer connected to the gas containment unit by a conduit, the pressure transducer configured to measure the gas pressure within the conduit; (b) a gas flow detector connected to the containment unit by the conduit, the gas flow detector configured to detect a flow rate of the gas through the conduit; and (c) a flow analysis unit configured to receive a signal from the gas flow detector indicating that the flow rate of the gas, wherein when the gas flow within the conduit has fallen below a pre-determined value, the flow analysis unit is configured to transmit a signal to the pressure transducer to measure the gas pressure within the conduit, the gas pressure of the conduit being substantially equivalent to the gas pressure within the gas containment unit.

### FIELD OF THE INVENTION

The invention relates to a system for monitoring pressure in a gas containment unit, and a method of using the system.

### BACKGROUND OF THE INVENTION

The internal pressure of a gas cylinder may be indirectly measured with a pressure transducer connected to piping external to the gas cylinder. The accuracy of a pressure transducer's measurements are affected by the open or closed state of the gas cylinder valve. More particularly, during an open state of the valve, the gas flows from the gas cylinder, through the connective piping, and into either equipment consuming the gas or another gas containment device. While the gas is flowing, the gas pressure within the connective piping becomes depressed due to flow droop, and measurements of the gas pressure taken during a time when the gas is flowing out of the cylinder may, therefore, not accurately reflect the true gas pressure and quantity of gas that remains within the gas cylinder. Systems and techniques for obtaining an accurate, automated measurement of the internal pressure of a gas cylinder are therefore desirable.

### SUMMARY OF THE INVENTION

Methods and systems for accurately measuring pressure within a gas cylinder are described.

According to one aspect of the invention, a gas pressure measurement system configured to indirectly measure an internal pressure of a gas containment unit is provided. The gas pressure measurement system comprises:
a. a pressure transducer fluidly connected to the gas containment unit by a conduit, the pressure transducer configured to measure the gas pressure within the conduit;
b. a gas flow detector fluidly connected to the containment unit by the conduit, the gas flow detector configured to detect a flow rate of the gas flowing through the conduit and transmit a signal corresponding to the detected flow rate; and
c. a flow analysis unit configured to receive the signal from the gas flow detector corresponding to the detected flow rate, wherein when the gas flow within the conduit falls below a pre-determined value, the flow analysis unit is configured to transmit a signal to the pressure transducer to measure the gas pressure within the conduit, said gas pressure within the conduit being substantially equivalent to the gas pressure within the gas containment unit.

According to another aspect of the invention, a method for obtaining an accurate measurement of pressure within a gas containment unit is provided. The method comprises the steps of:
a. detecting a flow rate of gas, using a gas flow detector, flowing through a conduit that is connected to the gas containment unit;
b. detecting, with the gas flow detector, when the flow rate of gas falls to or below a predetermined flow rate;
c. instructing a pressure transducer connected to the conduit to measure the gas pressure within the conduit; and
d. measuring the gas pressure within the conduit immediately after the flow rate of gas falls to or below the predetermined flow rate using the pressure transducer.

According to another aspect of the invention, another method for obtaining an accurate measurement of pressure within a gas containment unit is provided. The method comprises the steps of:
a. detecting a flow rate of gas, using a gas flow detector, flowing through a conduit that is connected to the gas containment unit;
b. determining when a duration of the gas flowing from the containment unit has exceeded a predetermined time threshold;
c. transmitting signals at scheduled intervals to a pressure transducer to take pressure measurement of the gas within the conduit after the predetermined time threshold of step (b) has been exceeded;
d. measuring the internal pressure of the conduit upon receiving the signals at the scheduled intervals using the pressure transducer;
e. detecting, with the gas flow detector, when the flow rate of gas falls in the conduit to or below a predetermined flow rate;
f. instructing a pressure transducer connected to the conduit to measure the gas pressure within the conduit; and
g. measuring the gas pressure within the conduit using the pressure transducer immediately after the flow rate of gas falls to or below the predetermined flow rate.

### BRIEF DESCRIPTION OF THE DRAWINGS

FIG. 1 depicts a system for monitoring pressure in a gas cylinder.

FIGS. 2 and 3 depict two exemplary methods for accurately measuring the internal gas pressure of a gas cylinder using the system of FIG. 1.

### DETAILED DESCRIPTION OF THE INVENTION

Aspects of the invention provide an improved means of obtaining an accurate, automated reading or measurement of the internal gas pressure of a gas cylinder.

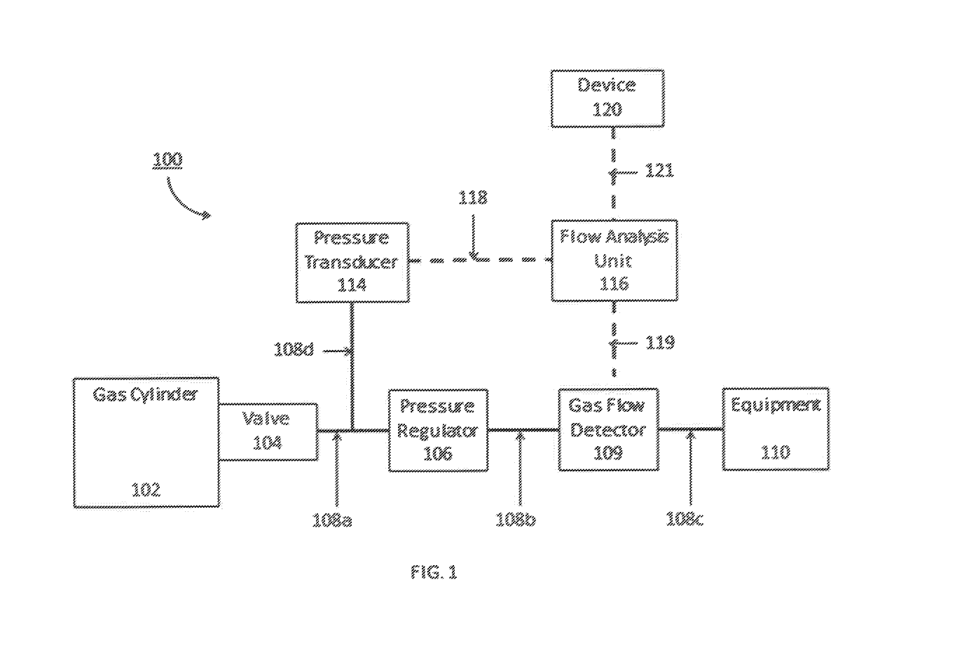

FIG. 1 depicts a system 100 for monitoring pressure in a gas cylinder. In FIG. 1, fluid carrying lines are depicted by solid lines and data communication lines are depicted by broken lines. The data communication lines may be either wired or wireless connections. Data may be transmitted bi-directionally through each communication line.

The system 100 generally includes a gas containment unit in the form of a gas cylinder 102, and a valve 104 that is fluidly connected to the gas cylinder 102 for controlling the flow of gas from the gas cylinder 102. Connective piping segments 108a-108d (referred to either individually or collectively as piping 108) are connected between the outlet of the valve 104 and equipment 110 for either consuming or storing the gas. The piping segments may also be referred to individually as pipes.

A pressure regulator 106 is connected to the valve 104 by piping segment 108a and is positioned downstream of the valve 104 for regulating the pressure of the gas to a pre-determined pressure. A pressure regulator is a valve that automatically cuts off the flow of a liquid or gas at a pre-determined pressure. Regulators are used to allow high-pressure fluid supply lines or tanks to be reduced to safe and/or usable pressures for various applications. The pressure regulator 106 may be a commercially available pressure regulator.

A gas flow detector 109 is connected to the pressure regulator 106 by piping segment 108b at a location downstream of the pressure regulator 106. The detector 109 is designed to detect the flow rate of the gas flowing through piping segment 108b. The gas flow detector 109 is configured to detect the flow rate of gas traveling through piping segment 108b. Although not shown, the gas flow detector 109 may be positioned at a location upstream of the pressure regulator 106. For example, the gas flow detector 109 may be connected to piping segment 108a. The gas flow detector 109 may be a commercially available gas flow detector.

The equipment 110 for either consuming or storing the gas is connected to the gas flow detector 109 by piping segment 108c at a location downstream of the gas flow detector 109. The equipment 110 may be another gas containment unit, or the equipment 110 may be a device that consumes the gas for various applications, such as a gas burner or a welding unit, for example.

A pressure transducer 114 is fluidly connected to piping segment 108d at a location that is downstream of the valve 104 and upstream of the pressure regulator 106. The pressure transducer 114 is configured to measure the gas pressure within the piping segment 108d. It should be understood that the gas pressure within segment 108d is equal to the gas pressure within segment 108a. The pressure transducer 114 may be a commercially available pressure transducer.

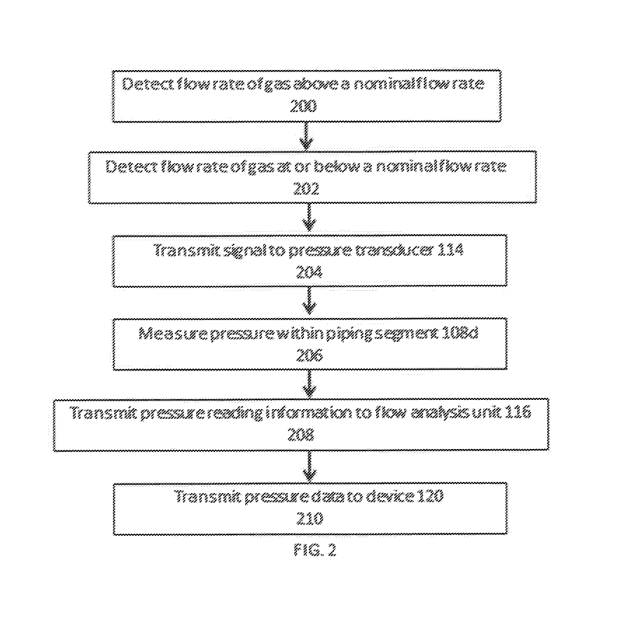

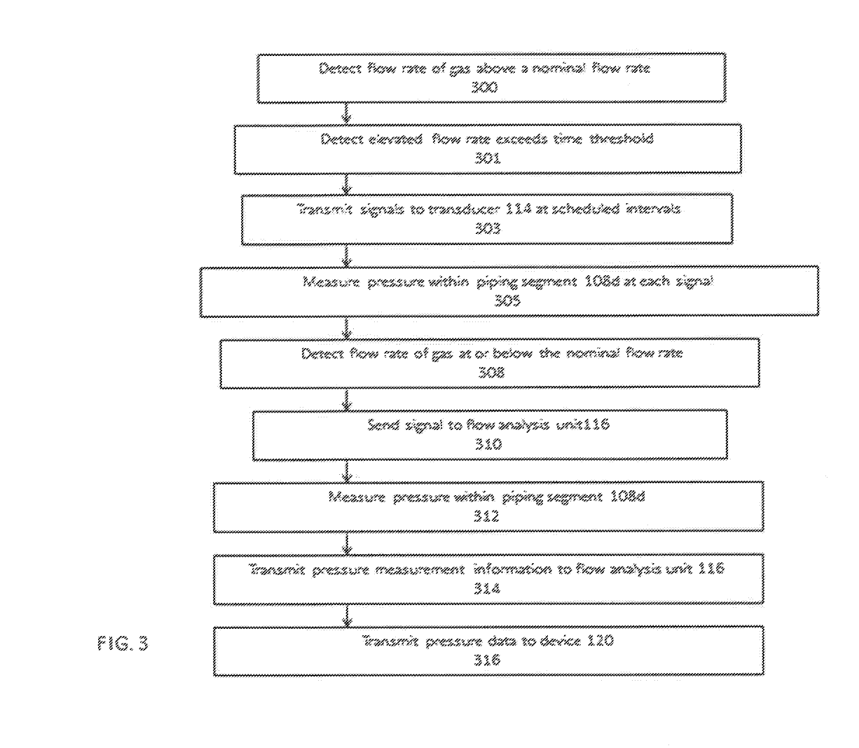

According to the exemplary methods of using the system, which are described in greater detail with respect to FIGS. 2 and 3, the gas pressure that is measured within the piping segment 108d by pressure transducer 114 can be either equal to or substantially equivalent to the gas pressure within the cylinder 102 at specific times during the method.

According to one aspect of the invention, the pressure transducer 114, the gas flow detector 109, and the pressure regulator 106 are each positioned exterior of the cylinder 102.

Referring now to the data communication lines of the system 100, the pressure transducer 114 includes a transmitter that transmits an analog or digital reading of the gas pressure within the piping segment 108d. The pressure transducer 114 transmits information related to the pressure readings to a flow analysis unit 116 via either a wired or wireless connection 118. Similarly, the gas flow detector 109 transmits information related to the flow of gas to the flow analysis unit 116 via either a wired or wireless connection 119. The flow analysis unit 116 may include a receiver for receiving information from the pressure transducer 114 and the gas flow detector 109, a computer processor for processing the received information, and a transmitter for transmitting the data to another device 120. The transmitter of the flow analysis unit 116 is also configured to instruct the pressure transducer 114 to measure the pressure at certain times and/or intervals, as is described in greater detail with respect to FIGS. 2 and 3. Accordingly, the pressure transducer 114 includes a receiver for receiving instructions from the flow analysis unit 116. The transmitter of the flow analysis unit 116 may also be configured to instruct (or activate) the gas flow detector 109 to measure the gas flow at certain times and/or intervals.

The flow analysis unit 116 is connected to a further processing device 120 by a wired or wireless connection 121. The device 120 may be a computer, a server, a computer database for storing the data, a Cloud based computing device or system, or a software tool, for example. Based upon the information provided by the flow analysis unit 116, the device 120 may be configured to determine when the cylinder 102 is either empty or nearly empty, and also configured to alert a user of such conditions. This feature of the system 100 may be useful for inventory purposes, for example. The device 120 may be configured to prompt the flow analysis unit 116 to transmit instructions to the pressure transducer 114 and/or the gas flow detector 109 at specified times. The flow analysis unit 116 and the device 120 may be integrated into a single computing unit.

FIGS. 2 and 3 depict two exemplary methods for accurately measuring the internal gas pressure of a gas cylinder 102 using the system 100 of FIG. 1. The first exemplary method of using the system 100 shown in FIG. 2 is useful for a process that frequently stops the flow of gas from the cylinder 102 before a significant portion of the capacity of cylinder 102 is exhausted. The second exemplary method of using the system 100 shown in FIG. 3 is useful for a process in which a significant portion of the capacity of cylinder 102 is exhausted in a single use.

With reference to FIG. 2, at block 200, the valve 104 is open, gas is flowing through system 100, and the gas flow detector 109 detects a flow rate of gas flowing through pipe 108b above a nominal flow rate. The nominal flow rate may be 10,000 liters per minute, for example. The detector 109 transmits a signal to the flow analysis unit 116 to indicate that the nominal flow rate has been exceeded, thereby indicating that a gas dosing process has begun. At block 202, at some point in time, the gas flow detector 109 detects a flow rate of the gas at or below the nominal flow rate, indicating that the gas cylinder valve 104 has closed or is closing. The nominal rate may be any particular pressure value depending upon the unique application of the system 100. At block 204, immediately after the detector 109 detects that the flow rate of gas is at or below the nominal rate, the detector 109 transmits a signal to the flow analysis unit 116 via connection 119, which in turn sends a signal to the pressure transducer 114 via connection 118 instructing the pressure transducer 114 to measure the gas pressure within piping segment 108d. At block 206, the pressure transducer 114 measures the pressure within piping segment 108d. At this particular moment in time, the pressure within piping segment 108d is substantially equal to the gas pressure within cylinder 102. This measurement process may be referred to as a “trailing edge trigger.” At block 208, the transmitter of the transducer 114 transmits a signal carrying the pressure measurement information to the flow analysis unit 116 via connection 118.

At block 210, the flow analysis unit 116 transmits the pressure reading data to processing device 120 via connection 121 for further processing, manipulation or storage of the data. The device 120 compares the data with stored data and determines whether a quantity of gas remaining within the gas cylinder has fallen below a pre-determined level, and, if so, the device alerts a user when the quantity of gas remaining within the gas containment unit has fallen below the pre-determined level.

With reference to FIG. 3, for a process that necessitates the valve 104 remain open for an extended period of time such that a significant portion of the gas within cylinder 102 is exhausted, it may be advantageous for the pressure transducer 114 to take continuous measurements at pre-determined intervals while the valve 104 remains open and the gas continues to flow above a nominal flow rate.

At block 300, the valve 104 is open, gas is flowing through system 100, and the gas flow detector 109 detects a flow rate of gas flowing through pipe 108b above a nominal flow rate. The detector 109 transmits a signal to the flow analysis unit 116 to indicate that the nominal flow rate has been exceeded, thereby indicating that a gas dosing process has begun. The flow analysis unit 116 measures the amount of time the flow rate of the gas has been elevated above the nominal flow rate based on signals received from the gas flow detector 109.

At block 301, the flow analysis unit 116 detects that the amount of time has exceeded the time threshold, which may be sixty seconds, for example. At block 303, after the time threshold has been exceeded, the flow analysis unit 116 transmits signals to the pressure transducer 114 at regular intervals (e.g., every 5 seconds) instructing the pressure transducer 114 to measure the pressure within the piping segment 108d. At block 305, the transducer 114 measures the pressure within the piping segment 108d. This measurement is a rough indicator of the gas pressure within the cylinder 102 until the valve 104 is closed or the gas is completely used.

Eventually, at block 308, the gas flow detector 109 detects a flow rate of the gas at or below the nominal rate, indicating that the gas cylinder valve 104 has closed or is closing, or that the gas cylinder 102 is nearly empty. The gas flow detector 109 transmits a signal corresponding to the decreased gas flow rate to the flow analysis unit 116 via connection 119. At block 310, when the detector 109 detects that the flow rate of gas is at or below the nominal rate, the detector 109 immediately transmits a signal to the flow analysis unit 116 via connection 119, which in turn transmits a signal to the pressure transducer 114 via connection 118 instructing the pressure transducer 114 to measure the gas pressure within piping 108d.

At block 312, the pressure transducer 114 measures the pressure within piping segment 108d. At this moment, the pressure within piping segment 108d is substantially equal to the gas pressure within cylinder 102. At block 314, the transmitter of the transducer 114 transmits a signal carrying the pressure measurement information to the flow analysis unit 116 via connection 118. At block 316, the flow analysis unit 116 transmits the pressure reading data to device 120 via connection 121 for further processing, manipulation or storage, as was described with reference to step 210 in FIG. 2.

Although the invention is illustrated and described herein with reference to specific embodiments, the invention is not intended to be limited to the details shown. Rather, various modifications may be made in the details within the scope and range of equivalents of the claims and without departing from the invention.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed is:

1. A gas pressure measurement system configured to indirectly measure an internal pressure of a gas containment unit, comprising:
a. a pressure transducer fluidly connected to the gas containment unit by a conduit, the pressure transducer configured to measure the gas pressure within the conduit;
b. a gas flow detector fluidly connected to the containment unit by the conduit, the gas flow detector configured to detect a flow rate of the gas flowing through the conduit and transmit a signal corresponding to the detected flow rate; and
c. a flow analysis unit configured to receive the signal from the gas flow detector corresponding to the detected flow rate, wherein when the gas flow within the conduit falls below a pre-determined value, the flow analysis unit is configured to transmit a signal to the pressure transducer to measure the gas pressure within the conduit, said gas pressure within the conduit being substantially equivalent to the gas pressure within the gas containment unit.

2. The gas pressure measurement system of claim 1, wherein the flow analysis unit is further configured to (i) determine a time duration of the gas flowing from the gas containment unit, and (ii) determine if the duration has exceeded a predetermined time threshold.

3. The gas pressure measurement system of claim 2, wherein the flow analysis unit is further configured to transmit an instruction signal to the pressure transducer to take pressure measurements at scheduled intervals when the gas flow detector determines that the time duration has exceeded the predetermined time threshold.

4. The gas pressure measurement system of claim 1, wherein the system further comprises a pressure regulator configured to regulate the gas pressure at a predetermined pressure.

5. The gas pressure measurement system of claim 1, wherein the flow analysis unit is further configured to instruct the gas flow detector to measure the flow rate of the gas at scheduled intervals.

6. The gas pressure measurement system of claim 1, wherein the system further comprises a device configured to receive data corresponding to the measured gas pressure within the conduit from the flow analysis unit.

7. The gas pressure measurement system of claim 6, wherein the device is further configured to determine if a quantity of gas within the gas containment unit has fallen below a pre-determined level.

8. The gas pressure measurement system of claim 7, wherein the device is further configured to alert a user when the quantity of gas within the gas containment unit has fallen below a pre-determined level.

9. A method for obtaining an accurate measurement of pressure within a gas containment unit, the method comprising:
a. detecting a flow rate of a gas, using a gas flow detector, flowing through a conduit that is connected to the gas containment unit;
b. detecting, with the gas flow detector, when the flow rate of the gas falls to or below a predetermined flow rate;
c. Instructing a pressure transducer connected to the conduit to measure the gas pressure within the conduit; and
d. measuring the gas pressure within the conduit immediately after the flow rate of gas falls to or below the predetermined flow rate using the pressure transducer.

10. The method of claim 9, wherein the method further comprises receiving, at a flow analysis unit, information about measured gas pressure from the pressure transducer.

11. The method of claim 10, wherein the method further comprises processing, at the flow analysis unit, the information about measured gas pressure received from the pressure transducer.

12. The method of claim 10, wherein the method further comprises transmitting, using the flow analysis unit, data about the measured gas pressure to a further processing device.

13. The method of claim 12, wherein the method further comprises determining if a quantity of gas within the gas containment unit has fallen below a pre-determined level.

14. The method of claim 13, wherein the method further comprises alerting a user when the quantity of gas within the gas containment unit has fallen below a pre-determined level.

15. A method for obtaining an accurate measurement of gas pressure within a gas containment unit, the method comprising:
a. detecting a flow rate of gas, using a gas flow detector, flowing through a conduit that is connected to the gas containment unit;
b. determining when a duration of the gas flowing from the containment unit has exceeded a predetermined time threshold;
c. transmitting signals at scheduled intervals to a pressure transducer to take pressure measurement of the gas within the conduit after the predetermined time threshold of step (b) has been exceeded;
d. measuring the internal pressure of the conduit upon receiving the signals at the scheduled intervals using the pressure transducer;
e. detecting, with the gas flow detector, when the flow rate of gas falls to or below a predetermined flow rate;
f. Instructing a pressure transducer connected to the conduit to measure the gas pressure within the conduit; and
g. measuring the gas pressure within the conduit immediately after the flow rate of gas falls to or below the predetermined flow rate using the pressure transducer.

16. The method of claim 15, wherein the method further comprises receiving, at a flow analysis unit, information about measured gas pressure from the pressure transducer.

17. The method of claim 16, wherein the method further comprises processing, at the flow analysis unit, the information about measured gas pressure received from the pressure transducer.

18. The method of claim 16, wherein the method further comprises transmitting, using the flow analysis unit, data about the measured gas pressure to a further processing device.

19. The method of claim 18, wherein the method further comprises determining if a quantity of gas within the gas containment unit has fallen below a pre-determined level.

20. The method of claim 19, wherein the method further comprises alerting a user when the quantity of gas within the gas containment unit has fallen below a pre-determined level.
